(19) United States
(12) Patent Application Publication
(10) Pub. No.: US 2024/0210206 A1
(43) Pub. Date: Jun. 27, 2024

(54) METHOD AND DEVICE FOR UPDATING AND PROVIDING A MAP

(71) Applicant: Robert Bosch GmbH, Stuttgart (DE)

(72) Inventor: Gerrit Schmitz, Kanagawa (JP)

(21) Appl. No.: 18/530,532

(22) Filed: Dec. 6, 2023

(30) Foreign Application Priority Data
Dec. 22, 2022 (DE) 10 2022 214 329.9

(51) Int. Cl. G01C 21/00

(52) U.S. Cl. CPC G01C 21/3841; G01C 21/3878; G01C 21/3885

(57) ABSTRACT

A method and device for updating and providing a map. The method includes receiving a plurality of data sets from a plurality of vehicles, wherein each data set comprises environment data values and position data values, wherein the environment data values represent an environment of the corresponding vehicle, wherein the position data values represent a position indication of the corresponding vehicle; a assigning the data sets to different data set groups depending on the position indication, wherein each data set group is assigned to a subregion of the map; updating all subregions of the map in which the corresponding data set groups comprise a sufficient quantity of data sets according to predefined criteria; creating the map depending on the updated subregions; and providing the map.

### CROSS REFERENCE

The present application claims the benefit under 35 U.S.C. § 119 of German Patent Application No. DE 10 2022 214 329.9 filed on Dec. 22, 2022, which is expressly incorporated herein by reference in its entirety.

### FIELD

The present invention relates, inter alia, to a method for updating and providing a map, wherein a plurality of data sets are received, and subregions of the map are updated depending on the data sets.

### SUMMARY

A method according to an example embodiment of the present invention for updating and providing a map comprises a step of receiving a plurality of data sets from a plurality of vehicles, wherein each data set comprises environment data values and position data values, wherein the environment data values represent an environment of the corresponding vehicle, wherein the position data values represent a position indication of the corresponding vehicle; and a step of assigning the data sets to different data set groups depending on the position indication, wherein each data set group is assigned to a subregion of the map. The method further comprises a step of updating all subregions of the map in which the corresponding data set groups comprise a sufficient quantity of data sets according to predefined criteria, a step of creating the map depending on the updated subregions, and a step of providing the map.

A map means a digital map in the form of (map) data values on a storage medium. The map is designed, for example, in such a way that one or more map layers are included, wherein a map layer shows, for example, a map from a bird's eye view (course and position of roads, buildings, landscape features, etc.). This corresponds, for example, to a map of a navigation system. A further map layer comprises, for example, a radar map, wherein environment features included in the radar map are stored with a radar signature. A further map layer comprises, for example, a lidar map, wherein environment features included in the lidar map are stored with a lidar signature. In a further embodiment, the map comprises, for example, a static and/or a dynamic map layer, wherein the static map layer comprises static objects (buildings, traffic signs, etc.) and the dynamic map layer comprises dynamic objects in the sense of a traffic density, etc. A subregion of the map means, for example, a section of one or more map layers.

The individual data sets comprise at least environment data values and a position indication of the relevant vehicle transmitting the data packet for receiving.

According to an example embodiment of the present invention, the environment data values are detected by means of an environment sensor system of the vehicle. An environment sensor system means at least one video sensor and/or at least one radar sensor and/or at least one lidar sensor and/or at least one ultrasonic sensor and/or at least one further sensor that is designed to detect an environment of the vehicle in the form of environment data values. In one possible embodiment, the environment sensor system comprises, for example, a computing unit (processor, memory, hard disk) with suitable software and/or is connected to such a computing unit for this purpose.

According to an example embodiment of the present invention, the position indication is detected by means of a suitable locating method. A locating method (GNSS positioning, GSM positioning, WLAN-based positioning, map-based positioning, etc.) in this case means a method suitable for determining a position and/or a direction of movement of a vehicle in a predefined coordinate system, for example WGS84 coordinates, wherein the position has a certain fuzziness. The fuzziness can be represented mathematically, for example as a Gaussian distribution, wherein the actually occurring fuzziness varies or depends on the type of locating method and/or the environment and/or further factors (weather conditions, etc.).

According to an example embodiment of the present invention, the corresponding locating method is carried out by means of a device designed for this purpose, which is included in the vehicle for this purpose. Depending on the design of the vehicle, it can be, for example, a navigation system and/or a smartphone connected to the automated vehicle and/or another device suitable for this purpose.

An assignment of the data sets to different data set groups means that all received data sets are sorted depending on the position indication, or so-called (data) clusters are formed from the individual data sets. In this case, each data set group or cluster is assigned to a subregion of the map and/or a map layer. In one possible embodiment, the map is subdivided, for example, into individual subregions of the same size (rectangles, etc.) or into certain traffic route portions (for example a traffic route between two traffic nodes). Each subregion thus has a specific position or a specific position region (area), and each of these subregions is thus assigned a specific data set group or cluster depending on a position indication.

According to an example embodiment of the present invention, if a predefined quantity of data sets per data set group is then reached or, accordingly, a predefined quantity of data sets per data set group was received, the corresponding subregion of the map is updated. The predefined quantity depends on the aforementioned predefined criteria. These specify, for example, how many data sets have to be present at minimum in order to be able to derive statistically relevant information from these data sets. The individual criteria can also be different from subregion to subregion. In a further embodiment, the predefined criteria additionally or alternatively specify, for example, that a data set is received at least once per day or that an update takes place at least once a day.

Creating the map in this case means that, in the already pre-existing map, all the subregions that have been updated in the preceding step are correspondingly inserted, and the subregions that are thus no longer current are removed from the map.

Providing the map means that the map can be retrieved, for example as a data set. In one possible form, this map and/or at least the updated subregions can be requested and received by a vehicle for operating (automated driving, planning a trajectory, etc.) this vehicle or as a service for this vehicle.

The method disclosed herein according to the present invention advantageously achieves the object of providing a method for updating a map. This object may achieved by means of the method according to the present invention in that all data sets required therefor are collected and assigned to so-called clusters. If a certain quantity of data sets per cluster is reached, the subregion of the map assigned to the cluster is updated. This allows the map or the individual subregions of the map to be used over a longer period of time without the map being updated with each incoming data set, and the map or the corresponding subregions thus being subject to constant changes, which make practical use of the map impossible. Furthermore, the method presented here allows an update to take place only when relevant statistical information can also be derived from the received data sets. This increases the quality of the individual updates and thus the quality of the map overall and furthermore leads to more safety with regard to the subsequent use of the map, for example for operating an automated vehicle.

According to an example embodiment of the present invention, the position indication preferably represents a position and/or a position progression of the corresponding vehicle.

A position progression means a trajectory. A trajectory means, for example, in relation to a map, a line (polygon) followed by the vehicle or a driving path through which the vehicle drives.

Further data sets are preferably additionally received from traffic monitoring devices and/or external servers, in particular weather stations.

Traffic monitoring devices mean, for example, traffic cameras on traffic lights, intersections, tunnel walls, bridge pillars, over freeways, etc. The further data sets likewise comprise a position indication of the corresponding traffic monitoring device.

External servers mean computing devices that likewise provide environment data values and position indications. These environment data values can likewise be detected, for example, using vehicles and/or in other ways (cameras, smartphones, etc.).

According to an example embodiment of the present invention, the device, in particular a computing unit, is configured to carry out all the steps of the method for updating and providing a map. A computing unit means, for example, a server or a server network or a cloud.

According to an example embodiment of the present invention, the device or the computing unit comprises a processor, memory, a storage medium, and suitable software in order to carry out the method according to one of the method disclosed herein. Furthermore, the device comprises an interface for transmitting and receiving data values, by means of a wired and/or wireless connection, for example with corresponding devices of vehicles (control units, communication devices, environment sensor system, navigation system, etc.) and/or further devices external to the vehicle (servers, cloud, etc.).

Furthermore, according to an example embodiment of the present invention, a computer program is provided, comprising commands that, when the computer program is executed by a computer, cause the computer to carry out a method according to one of the methods disclosed herein for updating and providing a map. In one embodiment, the computer program corresponds to the software included in the second device.

Also provided according to an example embodiment of the present invention is a machine-readable storage medium on which the computer program is stored.

Advantageous developments of the present invention are disclosed herein.

### BRIEF DESCRIPTION OF THE DRAWINGS

Exemplary embodiments of the present invention are shown in the FIGURE and explained in more detail in the following description.

FIG. 1 shows an exemplary embodiment of the method according to an example embodiment of the present invention for updating and providing a map, in the form of a flowchart.

### DETAILED DESCRIPTION OF EXAMPLE EMBODIMENTS

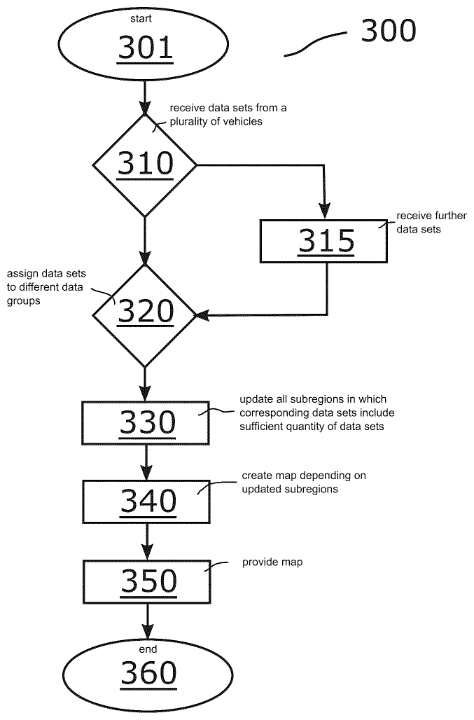

FIG. 1 shows an exemplary embodiment of a method 300 for updating 330 and providing 350 a map.

In step 301, the method 300 starts.

In step 310, a plurality of data sets are received from a plurality of vehicles, wherein each data set comprises environment data values and position data values, wherein the environment data values represent an environment of the corresponding vehicle, wherein the position data values represent a position indication of the corresponding vehicle.

In a further embodiment, further data sets are additionally received from traffic monitoring devices and/or external servers, in particular weather stations, in a step 315.

In step 320, the data sets are assigned to different data set groups depending on the position indication, each data set group being assigned to a subregion of the map.

In step 330, all subregions of the map in which the corresponding data set groups comprise a sufficient quantity of data sets according to predefined criteria are updated.

In step 340, the map is created depending on the updated subregions.

In step 350, the map is provided.

In step 360, the method 300 ends.

Wat is claimed is:

1. A method for updating and providing a map, the method comprising the following steps:
receiving a plurality of data sets from a plurality of vehicles, wherein each of the data sets includes environment data values and position data values, wherein the environment data values represent an environment of a corresponding vehicle of the vehicles, wherein the position data values represent a position indication of the corresponding vehicle;
assigning the data sets to different data set groups depending on the position indication, wherein each of the data set groups is assigned to a subregion of the map;
updating all subregions of the map in which the assigned data set groups include a sufficient quantity of data sets according to predefined criteria;
creating the map depending on the updated subregions; and
providing the map.

2. The method according to claim 1, wherein each position indication represents a position and/or a position progression of the corresponding vehicle.

3. The method according to claim 1, wherein further data sets are additionally received from traffic monitoring devices and/or external servers, including weather stations.

4. A device, comprising:
a computing unit configured to update and provide a map, the computing unit configured to:
receive a plurality of data sets from a plurality of vehicles, wherein each of the data sets includes environment data values and position data values, wherein the environment data values represent an environment of a corresponding vehicle of the vehicles, wherein the position data values represent a position indication of the corresponding vehicle;
assign the data sets to different data set groups depending on the position indication, wherein each of the data set groups is assigned to a subregion of the map;
update all subregions of the map in which the assigned data set groups include a sufficient quantity of data sets according to predefined criteria;
create the map depending on the updated subregions; and
provide the map.

5. A non-transitory machine-readable storage medium on which is stored a computer program for updating and providing a map, the computer program, when executed by a computer, causing the computer to perform the following steps:
receiving a plurality of data sets from a plurality of vehicles, wherein each of the data sets includes environment data values and position data values, wherein the environment data values represent an environment of a corresponding vehicle of the vehicles, wherein the position data values represent a position indication of the corresponding vehicle;
assigning the data sets to different data set groups depending on the position indication, wherein each of the data set groups is assigned to a subregion of the map;
updating all subregions of the map in which the assigned data set groups include a sufficient quantity of data sets according to predefined criteria;
creating the map depending on the updated subregions; and
providing the map.
